(19) United States
(12) Patent Application Publication
(10) Pub. No.: US 2010/0288851 A1
(43) Pub. Date: Nov. 18, 2010

(54) Multi-Channel Valves and Spray Containers Comprising Multi-Channel Valves

(75) Inventor: Philip Davies, Brussels (BE)

Correspondence Address: DINSMORE & SHOHL LLP, FIFTH THIRD CENTER, ONE SOUTH MAIN STREET, SUITE 1300, DAYTON, OH, 45402-2023, US

(73) Assignee: STORMES CUUVENE LTD., Guernsey (GB)

(21) Appl. No.: 12/467,159

(22) Filed: May 15, 2009

(51) Int. Cl. B05B 1/28; F04F 10/00

(52) U.S. Cl. 239/150; 137/124

(57) ABSTRACT

Provided are multi-channel valves comprising first and second siphon channels comprising first ends that are operably connected to each other; and (ii) at least one actuator, the actuator capable of movement between at least a first position (where the first siphon channel is occluded) and a second position (where the second siphon channel is occluded). Also provided are spray containers operable in a plurality of positions, the containers comprising multi-channel valves wherein movement of an actuator causes communication between a sprayer head and liquid contents of the container via at least one of two dip tubes to be disrupted, thereby facilitating the drawing of the liquid contents from the lowest point in the container.

### BACKGROUND

Myriad liquid products are distributed and sold in spray containers, which are typically used to dispense the liquid in a desired direction or on a desired surface. Examples of liquid products typically distributed in and dispensed by spray containers include, but are not limited to, carpet cleaners, fragrances, personal care products, cleaning products, pesticides, and herbicides. While there are numerous variations in design and purpose, known spray containers typically include a container body, a sprayer head positioned above the container body, and a dip tube.

Generally, the container bodies of known spray containers have a top with an opening through which liquids can pass, body sidewalls, and a substantially flat body bottom. The flat bottom may have a shape such as square, rectangular, circular, or oval. Container bodies can be made from a variety of materials suitable for the purpose of application and the nature of the liquid contents. Examples of such materials include, but are not limited to, plastics, glass, and metals.

The sprayer heads of spray containers typically have a manual or electric pumping mechanism, a venting mechanism, one or more check valves, a nozzle tip, and a discharge passage. Pumping mechanisms typically include a movable piston that, when actuated, causes a temporary pressure reduction that opens the check valve(s), thereby allowing communication of the reduced pressure from the sprayer head to the interior of the container via the dip tube. If the dip tube is in contact with the liquid contents of the container, the higher (atmospheric) pressure within the container drives the liquid up the dip tube through the check valve(s) and then through a discharge passage leading to a nozzle tip where a spray, stream, or foam is formed upon discharge from the sprayer head. Venting mechanisms (for example, a valve) prevent a vacuum from developing in the container as liquid is withdrawn by maintaining the pressure inside the container at or near atmospheric pressure. Check valves (for example, ball-type, poppet-type, and flap-type valves) allow flow of the liquid contents from the dip tube to the discharge passage when the pumping mechanism is actuated, while also preventing backflow of the liquid.

Dip tubes allow for communication between the interior of the container body and the sprayer head. Typically, a dip tube extends downward from a sprayer head such that the distal end of the tube extends into the fluid contents of a container. Thus, upon actuation of the pumping mechanism, a reduced pressure is communicated from the sprayer head to the liquid contents via the dip tube, and in response, liquid is delivered to the sprayer head via the dip tube.

Although spray containers are known, many suffer from the deficiency of having to be maintained in a substantially vertical position to function properly since tilting the container can cause the dip tube to lose contact with the liquid contents, particularly when the volume of the liquid in the container is low. If the dip tube is not in contact with the liquid contents, air or vapor from the container is passed through the dip tube, check valve(s), and discharge passage instead of the liquid, causing a loss in function and overall utility. As the liquid level in the container becomes increasingly low, the risk of such loss of function becomes increasingly high. Furthermore, since liquids are often discharged from a sprayer head in a substantially horizontal direction, problems can arise in applications where movement of a container outside of a substantially vertical position is needed. For example, when applying cleaner to a bathtub or weed killer to a weed, the user commonly orients a spray container away from of a substantially vertical position.

Therefore, there is a need for spray containers that can be used in multiple positions without loss of function.

### SUMMARY

This need is met by the multi-channel valves and spray containers comprising multi-channel valves provided by the present invention. In some embodiments, provided are valves comprising (i) at least first and second siphon channels comprising first ends that are operably connected to each other; and (ii) at least one actuator, the actuator being capable of movement between at least a first and a second position; wherein when the actuator is in the first position, the first siphon channel is occluded, and when the actuator is in the second position, the second siphon channel is occluded. In some aspects, the actuator may be selected from gravity-responsive assemblies, levers, switches, and clamping assemblies.

In other embodiments, provided are spray containers for dispensing liquids in a plurality of positions, said spray containers comprising at least one multi-channel valve. In certain aspects, such spray containers may be operated in a plurality of positions without loss of function. In certain aspects, when such a spray container is oriented away from a substantially vertical position, the multi-channel valve may increase the amount of liquid that can pass from the container body to the sprayer head from one dip tube while simultaneously decreasing the amount of liquid, air, or vapor that can pass from the container body to the sprayer head from the other dip tube.

These and additional embodiments of the invention will become apparent in the course of the following detailed description.

### BRIEF DESCRIPTION OF THE DRAWINGS

A more complete appreciation of the many embodiments of the invention will be readily obtained as the same becomes better understood by reference to the following detailed description when considered in connection with the accompanying drawings, wherein:

FIGS. 1 and 2 illustrate orthogonal cross-sections of a multi-channel valve having a weighted lever actuator;

FIG. 3 illustrates a multi-channel valve comprising an elongated siphon passage;

FIG. 4 illustrates a multi-channel valve comprising a lever and lever chamber above the slide channel;

FIGS. 5-7 illustrate the operation of the multi-channel valve of FIGS. 1 and 2 from the perspective of orthogonal cross-sections through (A) the slide channel and (B) the lever chamber of the valve;

FIG. 8 illustrates that instead of weighted levers, multi-channel valves can have slide members operably connected to switches of various types. For example, depicted are (A) a slide member operably connected to a side-actuated switch and (B) a slide member operably connected to an end-actuated switch;

FIG. 9 illustrates that various types of levers, clamps, and clamping assemblies can be actuators. For example, depicted is an actuator comprising a non-weighted lever operably connected to a manual activating element. Also depicted is a clamping assembly for selective clamping of siphon channels made of a flexible material;

FIG. 10 illustrates that an actuator need not be operably connected to a slide member. For example, depicted is a gravity-responsive assembly comprising weighted valve members for selective occlusion of siphon channels;

FIG. 11 illustrates a trigger spray container comprising a multi-channel valve; and

FIG. 12 illustrates a pump spray container comprising a multi-channel valve.

### DETAILED DESCRIPTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention.

As used in the description of the invention and the appended claims, the singular forms “a,” “an,” and “the” are intended to include the plural forms as well, unless the context clearly indicates otherwise.

The term “communicate,” as used in the description of the invention and the appended claims, is intended to mean transfer, move, join, or connect. For example, if component A is in communication with component B, they are connected by some means allowing for transfer of for example, a liquid, between the two components.

As used in the description of the invention and the appended claims, the term “liquid” is intended to include, but not be limited to, fluids, emulsions, gels, and pastes.

The term “operably connected,” as used in the description of the invention and the appended claims, is intended to mean combined by any suitable means allowing for functional operation, including but not limited to, mechanical movement and the flow of liquid. Suitable means include, but are not limited to, threaded connections; bayonet connections; snap connections; ratchet connections; couplings; fittings such as a luer, tee, y, cross, multi-port, and an elbow; mechanical bonding; and chemical bonding.

As used in the description of the invention and the appended claims, the term “oriented” is intended to mean positioned or arranged in relation to a substantially vertical position.

As used in the description of the invention and the appended claims, the term “substantially” is intended to mean “absolute,” as well as “almost.” Accordingly, the term “substantially vertical” is intended to mean absolutely vertical, as well as almost vertical. Similarly, the term “substantially horizontal” is intended to mean absolutely horizontal, as well as almost horizontal.

Unless otherwise indicated, all numbers expressing quantities, properties, weights, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

According to various embodiments, provided are multi-channel valves comprising: (i) at least first and second siphon channels comprising first ends that are operably connected to each other; (ii) at least one actuator, the actuator capable of movement between at least a first and a second position; (iii) a slide channel positioned between the first and second siphon channels; and (iv) a slide member housed within the slide channel and capable of movement therein, the slide member operably connected to the actuator and of sufficient dimensions to occlude at least one of the first and second siphon channels. When the actuator is moved, the slide member moves such that when the actuator is in the first position, the slide member occludes the first siphon channel, and when the actuator is in the second position, the slide member occludes the second siphon channel.

The actuator can be any suitable mechanism allowing for control of occlusion of the siphon channels. In certain aspects, actuators are selected from gravity-responsive assemblies, levers, switches, and clamping assemblies. In certain embodiments, the actuator is a weighted lever that is pivotally mounted such that it moves in response to gravity, the lever comprising a first end that engages the slide member and a weighted second end. Accordingly, when a valve comprising such an actuator is increasingly oriented away from a substantially vertical position, the second end of the weighted lever shifts in response to gravity causing the weighted lever to move towards one of the first or second positions, and the slide member moves to increase occlusion of one of the first and second siphon channels while decreasing occlusion of the other of the first and second siphon channels by a corresponding amount.

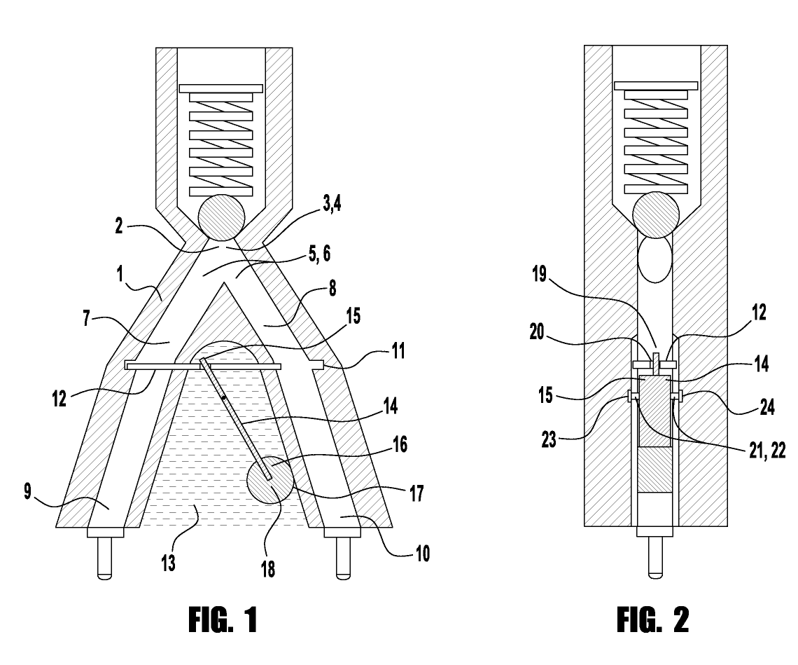

Referring to FIG. 1, a multi-channel valve of the invention may, in certain aspects, comprise a housing 1; and a siphon passage 2 defined within the housing 1, the siphon passage 2 having first 3 and second 4 ends, wherein the second end 4 is operably connected to first ends 5, 6 of first 7 and second 8 siphon channels, and wherein the siphon channels 7, 8 have independent second ends 9, 10. In some aspects (as shown), the first ends 5, 6 of the siphon channels 7, 8 are operably connected to each other and the second end 4 of the siphon passage 2 such that they are joined as a unified, functioning whole. In other aspects (not shown), the first and second siphon channels and the siphon passage may be operably connected by a coupling or fitting. In further aspects (not shown) a multi-channel valve can have more than two siphon channels. For example, a valve may have 3 siphon channels. In an alternative example, a valve may have 4 siphon channels.

A multi-channel valve of the invention may further comprise, as depicted in FIG. 1, a planar slide channel 11 bisecting the siphon channels 7, 8; and a planar slide member 12 housed within the slide channel 11, the slide member 12 being capable of moving laterally therein to fully occlude at least one of the siphon channels 7, 8. In alternative aspects (not shown), a slide channel does not bisect the siphon channel. In further alternative aspects (not shown), a slide channel and a slide member are non-planar. In certain aspects (as shown), the slide member 12 may fully occlude one siphon channel and not occlude the other siphon channel. However, in alternative aspects (not shown) the slide member is capable of partially occluding both of the siphon channels in certain positions, or fully occluding one of the siphon channels while partially occluding the other siphon channel.

Also referring to FIG. 1, a multi-channel valve of the invention may, in certain aspects, comprise a lever chamber 13 and a lever 14 pivotally mounted at a pivot point (not shown) within the lever chamber 13, wherein the lever 14 comprises a first end 15 that engages the slide member 12 at an aperture (not shown) and a second end 16 that is operably connected to a weight 17. In further aspects, as shown, the lever chamber 13 is defined between the first 7 and second 8 siphon channels, but alternative positioning (for example, to one side of the siphon channels) is also contemplated. As shown, the second end 16 of the lever 14 may fit within a recess 18 within the weight 17, but other means of attachment (for example, mechanical or chemical bonding) are also contemplated. Additionally, the lever chamber may either have one or more openings allowing communication outside of the housing or be sealed by or fully enclosed within the housing.

In some aspects, a lever having a weighted second end may be the actuator. The shape of the lever may be any suitable shape, including but not limited to cylindrical, square, or rectangular (as shown). In certain aspects, the second end of the lever is operably connected to a weight. The shape of the weight can be cylindrical (as shown), spherical, square, rectangular, or any other suitable shape. The mass of the weight can be any mass suitable for operation and will depend, in part, on where the pivot point is set, the length of the lever, and the weight of the lever. The mass of the weight will also depend upon the friction of the system, which in turn, depends on manufacturing tolerances.

Referring to FIG. 2, which is an orthogonal cross-section through the multi-channel valve shown in FIG. 1, the first end 15 of a lever 14 of a valve of the invention may, in certain aspects, comprise a projection 19 protruding through an aperture 20 in the center of the slide member 12; and at its pivot point, a pair of projections 21, 22 that are oriented 180 degrees from each other. Each projection 21, 22 engages a corresponding recess 23, 24 in the housing 1 such that the lever 14 is pivotally mounted and can position or reposition itself with respect to gravity. In alternative aspects (not shown), the housing could have projections that engage corresponding recesses on the lever such that the lever is pivotally mounted. In further aspects (not shown), the projection can be coupled to the slide member, or the slide member and lever can be a single unit.

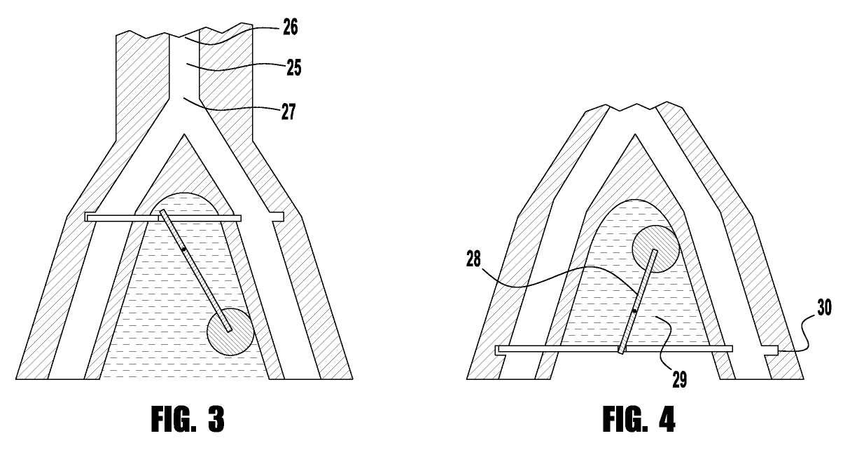

Referring to FIG. 3, a multi-channel valve of the invention may have an elongated siphon passage 25, wherein the length between the first 26 and second 27 ends of the siphon passage 25 is greater than minimal (in contrast to the siphon passage of FIG. 1, which is a siphon passage of minimal length). In alternative aspects (not shown), a valve of the invention does not have a siphon passage.

Referring to FIG. 4, a multi-channel valve of the invention may have a lever 28 and lever chamber 29 positioned above the slide channel 30.

In some aspects, the slide channel of a valve of the invention may comprise a gasket proximate to the slide member to improve sealing of the siphon channels when sufficient tension is created between the gasket and the slide member. In further aspects, the slide member may comprise a coating, such as an elastomeric or silicone-based coating, to improve lubricity, reduce friction, and facilitate sealing of the siphon channels. In additional aspects, the orientation-sensitive valve may be coupled to or integrated with a check valve, which can be of any type known in the art, such as a ball-type valve, poppet-type valve, or a flap-type valve.

According to certain embodiments, a multi-channel valve may be gravity-responsive such that when oriented in a substantially vertical position, gravity maintains a weighted lever actuator in a substantially vertical position and the slide member partially occludes both of the first and second siphon channels by a predetermined amount, and when said valve is oriented away from the substantially vertical position by any of a plurality of orientations, gravity repositions the lever causing the slide member to move laterally in a direction opposite the second end of the lever to increasingly occlude one of the first and second siphon channels by a predetermined amount while simultaneously decreasing occlusion of the other of the first and second siphon channels by a corresponding amount.

In alternative embodiments, a multi-channel valve is not gravity-responsive. When the actuator (for example, a manual switch) of such a valve is actuated, the slide member moves in response to occlude or partially occlude one of the first and second siphon channels. In some aspects, the actuator of such a valve is positionable in a plurality of positions such that as the actuator moves between the first position (where the first siphon channel is occluded) and the second position (where the second siphon channel is occluded), one siphon channel becomes increasingly occluded by a predetermined amount while occlusion of the other siphon channel decreases by a corresponding amount.

Therefore, valves of the invention (whether gravity-responsive or not) are contemplated to be operable in a plurality of positions. For example, the valves of the invention are contemplated to be operable within 90° either direction from the substantially vertical position (i.e. ranging from substantially horizontal to substantially vertical to opposing substantially horizontal positions). Thus, the valves (and spray containers comprising said valves) may be operable within 1°-5°, 6°-10°, 11°-15°, 16°-20°, 21°-25°, 26°-30°, 31°-35°, 36°-40°, 41°-45°, 46°-50°, 51°-55°, 56°-60°, 61°-65°, 66°-70°, 71°-75°, 76°-80°, 81°-85°, and 86°-90° from the substantially vertical position.

Referring to FIG. 5, in certain aspects, a multi-channel valve of the invention may have a weighted lever as the actuator (and a spray container may comprise said valve). When such valve (or container) is oriented in a substantially vertical position, gravity positions the weighted lever 14 in a substantially vertical position. In some aspects, when such a valve (or spray container comprising such valve) is in a “substantially vertical” position, the lever 14 and slide channel 11 form an angle 31 of from about 85° to about 95°. For example, the angle may be 85°, 86°, 87°, 88°, 89°, 90°, 91°, 92°, 93°, 94°, or 95°. In further aspects, when positioned in a “substantially vertical position,” the slide member 12 may partially occlude both of the siphon channels 7, 8 by a predetermined amount, wherein the sum of the degree of occlusion for both siphon channels is equivalent to 100% occlusion of the cross-sectional area of one siphon channel. In certain aspects, when such a valve is in a “substantially vertical” position, the slide member 12 may occlude from about 45% to about 55% of each of the siphon channels, wherein combined occlusion is equivalent to 100% of the cross-sectional area of one siphon channel. For example, occlusion of one siphon channel may be 45%, 46%, 47%, 48%, 49%, 50%, 51%, 52%, 53%, 54%, or 55% while occlusion of the other may be 55%, 54%, 53%, 52%, 51%, 50%, 49%, 48%, 47%, 46%, or 45%. Thus, if one siphon channel is occluded by 53%, the other siphon channel would be occluded by 47%. In alternative aspects, when positioned in a “substantially vertical” position, the slide member either partially occludes only one siphon channel or does not occlude either siphon channel.

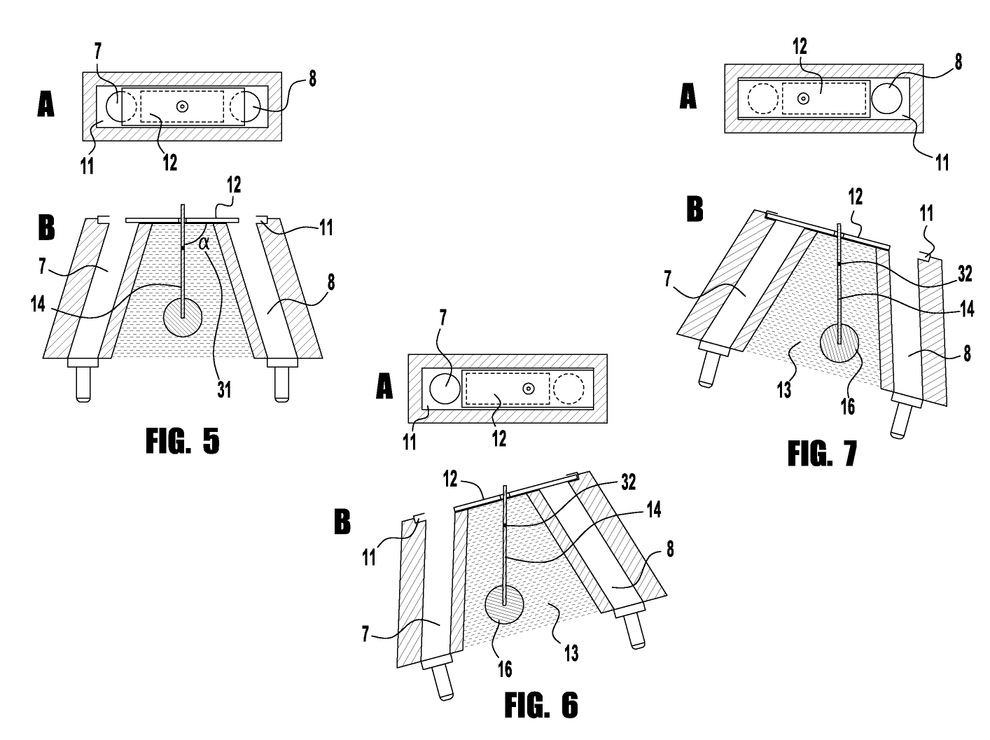

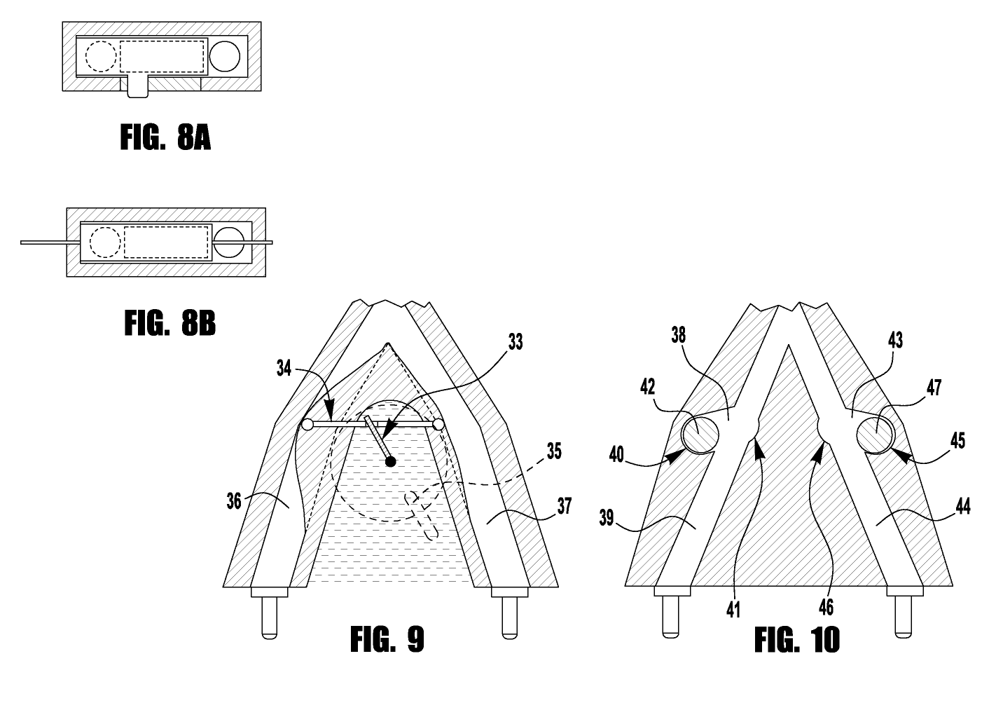

Referring to FIGS. 6 and 7, when the valve (or spray container comprising said valve) shown in FIG. 5 is oriented away from a substantially vertical position, the weighted lever 14 is positioned or repositioned with respect to gravity within the lever chamber 13 by pivoting at the pivot point 32, wherein such movement is transferred to the slide member 12, thereby causing the slide member 12 to move laterally in the slide channel 11 in a direction opposite the second end 16 of the lever 14. Thus, the weighted lever 14 can assume a plurality of orientations in response to gravity, thereby causing the slide member 12 to assume a plurality of lateral positions within the slide channel 11. In some aspects, when the valve (or spray container comprising the valve) is oriented away from a substantially vertical position by an angle less than 30°, the slide member 12 may occlude from about 0% to about 15% of the siphon channel 7, 8 proximate to the second end 16 of the lever 13, and from about 85% to about 100% of the other siphon channel 7, 8. For example, when such valve (or container) is oriented away from a substantially vertical position by an angle of 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, or 30°, the slide member may occlude any of 0%, 1%, 2%, 3%, 4%, 5%, 6%, 7%, 8%, 9%, 10%, 11%, 12%, 13%, 14%, or 15% of the siphon channel proximate to the second end of the lever, and any of 100%, 99%, 98%, 97%, 96%, 95%, 94%, 93%, 92%, 91%, 90%, 89%, 88%, 87%, 86%, or 85% of the other siphon channel such that the combined occlusion is equivalent to 100% of the cross-sectional area of one siphon channel. In certain aspects, when a valve (or spray container comprising the valve) is oriented away from a substantially vertical position by an angle of from about 5° to about 15°, the slide member may occlude about 0% of the siphon channel proximate to the second end of the lever, and about 100% of the other siphon channel. For example, when such valve (or spray container) is oriented away from a substantially vertical position by an angle of 5°, 6°, 7°, 8°, 9°, 10°, 11°, 12°, 13°, 14°, or 15°, the slide member may occlude about 0% (including 0%) of the siphon channel proximate to the second end of the lever, and about 100% (including 100%) of the other siphon channel.

In alternative aspects, it is contemplated that a valve (or spray container comprising the valve) can be configured such that when oriented away from a substantially vertical position by an angle greater than or equal to 30°, the slide member may occlude from about 0% to about 5% of the siphon channel proximate to the second end of the lever, and from about 95% to about 100% of the other siphon channel. For example, when such valve (or spray container) is oriented away from a substantially vertical position by an angle of from 30°-35°, 36°-40°, 41°-45°, 46°-50°, 51°-55°, 56°-60°, 61°-65°, 66°-70°, 71°-75°, 76°-80°, 81°-85°, or 86°-90° the slide member may occlude any of 0%, 1%, 2%, 3%, 4%, or 5% of the siphon channel proximate to the second end of the lever, and any of 100%, 99%, 98%, 97%, 96%, or 95% of the other siphon channel such that the combined occlusion is equivalent to 100% of the cross-sectional area of one siphon channel.

According to various embodiments, actuators of a multi-channel valve of the invention may be selected from gravity-responsive assemblies, levers, switches, and clamping assemblies. Referring to FIG. 9, a valve of the invention may, in certain aspects, comprise a non-weighted lever 33 operably connected to a slide member 34. As shown, the lever 33 may also be operably connected to a manual activating element 35 (for example, a dial). Movement of the lever 33 (by manual movement of the activating element 35) causes movement of the slide member 34 such that when the lever 33 is in the first position, the slide member 34 occludes the first siphon channel 36, and when the lever 33 is in the second position, the slide member 34 occludes the second siphon channel 37. In further aspects (as shown), movement of the actuator may cause clamping of the siphon channels 36, 37 when the siphon channels 36, 37 are of a flexible material.

In some aspects, the actuator (for example, lever) of a valve of the invention is movable between the first position (where the first siphon channel is occluded) and the second position (where the second siphon channel is occluded) (or vice versa), as well as a plurality of positions between the first and second positions. In certain aspects, as the actuator moves, one siphon channel becomes increasingly occluded by a predetermined amount while occlusion of the other siphon channel decreases by a corresponding amount.

According to certain embodiments, a multi-channel valve of the invention (and a spray container comprising said valve) does not necessarily comprise a slide member, and thus, the actuator does not necessarily have to be connected to a slide member. For example, referring to FIG. 10, an actuator may be a gravity-responsive assembly comprising: (A) a first valve chamber 38 operably connected to a first siphon channel 39, the first valve chamber 38 comprising: (i) a first valve seat 40; (ii) a second valve seat 41; and (iii) a first weighted valve member 42 capable of alternately seating against the first 40 and second 41 valve seats in response to gravity, the first weighted valve member 42 being of sufficient dimensions to occlude the first siphon channel 39 when seated against the second valve seat 41 while in a first position; and (B) a second valve chamber 43 operably connected to a second siphon channel 44, the second valve chamber 43 comprising: (i) a first valve seat 45; (ii) a second valve seat 46; and (iii) a second weighted valve member 47 capable of alternately seating against the first 45 and second 46 valve seats in response to gravity, the second weighted valve member 47 being of sufficient dimensions to occlude the second siphon channel 44 when seated against the second valve seat 46 while in a second position. When such a valve is increasingly oriented away from a substantially vertical position, the weighted valve members 42, 47 shift in response to gravity and move to first or second positions to occlude one of the first 39 and second 44 siphon channels. In some aspects, when the valve is in the substantially vertical position, both valve members are seated against the first seats. In alternative aspects, when the valve is in the substantially vertical position, one valve member is seated against the first seat and the other valve member is seated against the second seat.

According to additional embodiments, provided are spray containers that may be operated in a plurality of positions (including, but not limited to, anywhere from substantially vertical to substantially horizontal). In some aspects, said spray containers may comprise: (I) a container body comprising a bottom; (II) a sprayer head operably connected to the container body; (III) at least one multi-channel valve operably connected to the sprayer head, the multi-channel valve comprising: (i) at least first and second siphon channels comprising first ends that are operably connected to each other and independent second ends; (ii) at least one actuator, the actuator capable of movement between at least a first and a second position; (iii) a slide channel positioned between the first and second siphon channels; (iv) a slide member housed within the slide channel and capable of movement therein, the slide member operably connected to the actuator and of sufficient dimensions to occlude at least one of the first and second siphon channels; wherein movement of the actuator causes movement of the slide member; and (IV) at least first and second dip tubes, each comprising (i) a first end operably connected with one of the second ends of the first and second siphon channels, and (ii) a second end proximate to the bottom of the container body. When the actuator of said spray container is in the first position, the first siphon channel is occluded and communication between the container body and sprayer head (via the first dip tube) is disrupted, and when the actuator is in the second position, the second siphon channel is occluded and communication between the container body and sprayer head (via the second dip tube) is disrupted.

In alternative aspects, spray containers of the invention may comprise: (I) a container body comprising a bottom; (II) a sprayer head operably connected to the container body; (III) at least one multi-channel valve operably connected to the sprayer head, the multi-channel valve comprising: (A) at least first and second siphon channels comprising first ends that are operably connected to each other, and independent second ends; (B) at least one actuator, the actuator capable of movement between at least a first and a second position, the actuator comprising: (i) a first valve chamber operably connected to the first siphon channel, the first valve chamber comprising: (a) a first valve seat; (b) a second valve seat; and (c) a first weighted valve member capable of alternately seating against the first and second valve seats in response to gravity; wherein when the actuator is in the first position, the first weighted valve member is seated against the second valve seat and occludes the first siphon channel; and (ii) a second valve chamber operably connected to the second siphon channel, the second valve chamber comprising: (a) a first valve seat; (b) a second valve seat; and (c) a second weighted valve member capable of alternately seating against the first and second valve seats in response to gravity; wherein when the actuator is in the second position, the second weighted valve member is seated against the second valve seat and occludes the second siphon channel; and (IV) at least first and second dip tubes, each comprising (i) a first end operably connected with one of the second ends of the first and second siphon channels, and (ii) a second end proximate to the bottom of the container body. When said spray container is increasingly oriented away from a substantially vertical position, the weighted valve members shift in response to gravity and move to the first or second positions; wherein when the actuator is in the first position, the first siphon channel is occluded and communication between the container body and sprayer head (via the first dip tube) is disrupted, and when the actuator is in the second position, the second siphon channel is occluded and communication between the container body and sprayer head (via the second dip tube) is disrupted.

In various embodiments, the actuators of spray containers of the invention may be selected from gravity-responsive assemblies (including, but not limited to, an assembly as illustrated in FIG. 10); levers (including, but not limited to, weighted levers as illustrated in FIG. 1); switches, and clamping assemblies.

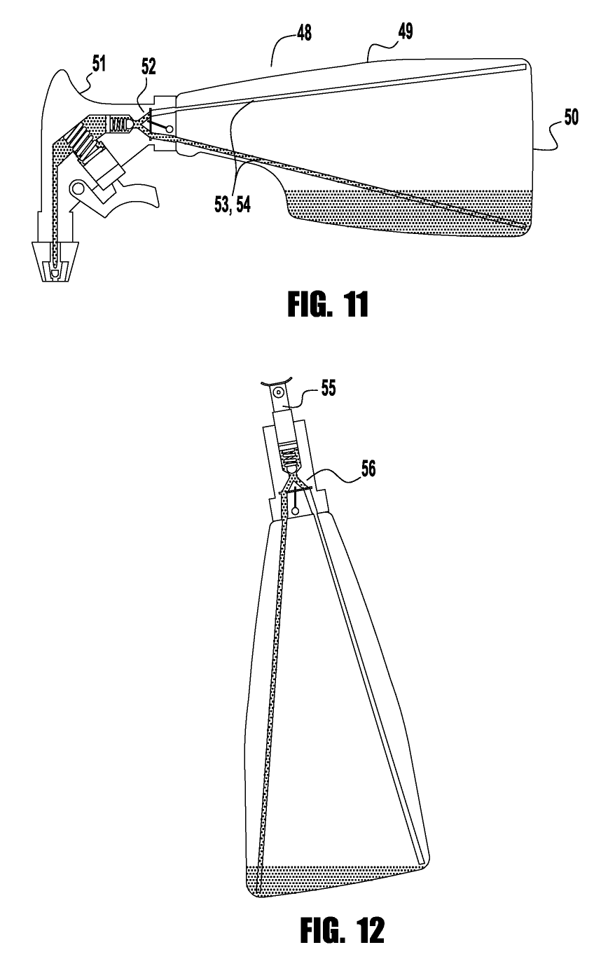

Referring to FIG. 11, a spray container of the invention may comprise a container body 48; sidewalls 49; a bottom 50; a trigger sprayer head 51 comprising a multi-channel valve 52 operably connected to, and housed within, the sprayer head 51; and first and second dip tubes 53, 54 operably connected to the multi-channel valve 52. Referring to FIG. 12, a spray container of the invention may also comprise a pump sprayer head 55 operably connected to a multi-channel valve 56.

According to some embodiments, a spray container of the invention may comprise a multi-channel valve comprising a weighted lever actuator that is pivotally mounted such that it moves in response to gravity, the lever comprising a first end that engages the slide member and a second end. When such a spray container is oriented in a substantially vertical position, gravity maintains the weighted lever in a substantially vertical position and the slide member partially occludes both of the first and second siphon channels by a predetermined amount, allowing for communication (via both dip tubes) between the interior of the container body and the sprayer head. When said spray container is oriented away from the substantially vertical position, gravity positions or repositions the lever causing the slide member to move laterally to increasingly occlude one of the first and second siphon channels by a predetermined amount, thereby reducing communication (via the corresponding dip tube) between the liquid contents of the spray container and the sprayer head. Simultaneously, occlusion of the other of the first and second siphon channels is decreased by a corresponding amount, thereby increasing communication (via the corresponding dip tube) between the liquid contents of the spray container and the sprayer head.

Spray containers of the invention are contemplated to be operable in a plurality of positions including, but not limited to, in a substantially horizontal position (as shown in FIG. 11). In certain aspects, movement of the actuator (for example, by orientation away from a substantially vertical position), causes occlusion of one of the first and second siphon channels to increase while also causing occlusion of the other siphon channel to decrease by a corresponding amount. Thus, communication between the container body and the sprayer head via one of the first and second dip tubes is increased communication between the container body and the sprayer head via the other dip tube is decreased. Provided that at least one dip tube remains in contact with the liquid contents of the container, the spray containers of the invention are designed such that a constant degree of communication between the liquid contents and the sprayer head can be maintained. For example, the spray containers of the invention are contemplated to be operable within 90° either direction from the substantially vertical position (i.e. ranging from substantially horizontal to substantially vertical to opposing substantially horizontal positions). Thus, the spray containers may be operable within 1°-5°, 6°-10°, 11°-15°, 16°-20°, 21°-25°, 26°-30°, 31°-35°, 36°-40°, 41°-45°, 46°-50°, 51°-55°, 56°-60°, 61°-65°, 66°-70°, 71°-75°, 76°-80°, 81°-85°, and 86°-90° from the substantially vertical position.

In certain aspects, when a spray container of the invention is oriented away from a substantially vertical position by an angle less than 30°, from about 0% to about 15% of one of the first and second siphon channels becomes occluded, and from about 85% to about 100% of the other siphon channel becomes occluded. For example, when such a container is oriented away from a substantially vertical position by an angle of 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, or 30°, occlusion of one of the first and second siphon channels may be any of 0%, 1%, 2%, 3%, 4%, 5%, 6%, 7%, 8%, 9%, 10%, 11%, 12%, 13%, 14%, or 15%, and occlusion of the other siphon channel may be any of 100%, 99%, 98%, 97%, 96%, 95%, 94%, 93%, 92%, 91%, 90%, 89%, 88%, 87%, 86%, or 85% such that the combined occlusion is equivalent to 100% of the cross-sectional area of one siphon channel.

With respect to a spray container comprising a multi-channel valve of the invention, occlusion of one siphon channel (caused by movement of the actuator) blocks movement of air, vapor, or liquid from the container interior to the sprayer head via the corresponding dip tube, which allows negative pressure resulting from actuation of the pumping mechanism in the sprayer head to move liquid from the interior of the container to the sprayer head through the other (open) siphon channel via its corresponding dip tube. Thus, it is contemplated that negative pressure arising from actuation of the pumping mechanism will cause the liquid to pass through at least one of the dip tubes, through at least one of the siphon channels, and through the sprayer head from which it is ultimately discharged.

In certain aspects, it is contemplated that when certain spray containers of the invention are oriented in a substantially vertical position, negative pressure arising from actuation of the pumping mechanism will cause the liquid to pass through both of the dip tubes, through both of the siphon channels, and through the sprayer head from which it is ultimately discharged. In further aspects, it is contemplated that when such containers are oriented away from the substantially vertical position, negative pressure arising from actuation of the pumping mechanism will cause the liquid to continue passing through both dip tubes (assuming that both dip tubes are in contact with liquid and that each siphon channel has less than 100% occlusion), through both siphon channels, and through the sprayer head from which it is ultimately discharged. However, as such a spray container becomes increasingly horizontal (i.e. is positioned increasingly further away from substantially vertical), one siphon channel will become increasingly occluded and less liquid will be able to pass through that siphon channel (and corresponding dip tube) to the sprayer head but the other siphon channel will become decreasingly occluded and more liquid will be able to pass through that siphon channel (and corresponding dip tube) to the sprayer head. Accordingly, at some predetermined position, one siphon channel will become fully occluded (i.e. the first or second position) while the other siphon channel is not occluded. Therefore, actuation of the actuator allows for constant communication between the interior of the container and the sprayer head (assuming at least one dip tube remains in contact with the liquid). Thus, the liquid of a container may continuously be drawn from at least the lowest point (with respect to placement of the second ends of the dip tubes) in the spray container, which allows the spray container to remain functional for delivery of liquid contents in a plurality of orientations (for example, ranging from substantially vertical to substantially horizontal, including when the sprayer head is upward facing or downward facing). Where the actuator is a weighted lever, this is an automatic process since the dip tube corresponding to the siphon channel furthest from the second end of the weighted lever will be the first to lose contact with the liquid, and little or no air or vapor will be pumped through that dip tube since increasing the horizontal orientation increases occlusion of the corresponding siphon channel.

It is also contemplated that when a spray container of the invention is oriented by small departures from a substantially vertical position, there may be complete occlusion of one of the siphon channels (which prevents communication between the corresponding dip tube and the sprayer head) and the complete opening of the other siphon channel (which allows full communication between the corresponding dip tube and the sprayer head).

According to some aspects, spray containers of the invention comprise dip tubes that are operably connected with a multi-channel valve and extend therefrom toward the bottom of the container body. In some aspects, the dip tubes are integrated with sidewalls of the container body, but in other aspects, the dip tubes and container body are separate and independent components. Regardless of whether integrated with or separate from the sidewalls, the second ends of the dip tubes may be positioned proximate to where the bottom and sidewalls join such that at least one dip tube extends into at least low levels of the liquid throughout a plurality of positions of the spray container.

According to some embodiments, an actuator of a spray container of the invention comprises a weighted lever pivotally mounted in a lever chamber, said lever chamber being positioned either above or below a slide channel housing a slide member. To achieve pivotal mounting, the weighted lever may comprise a pair of opposing projections that engage a pair of opposing recesses in the lever chamber. Alternatively, the lever may comprise a pair of opposing recesses that engage a pair opposing projections in the lever chamber. In further aspects, the lever may have one or more projections that engage an aperture in the slide member, or the lever may be operably connected with the slide member.

The valves and containers (and their respective components) of the invention can be made out of any material suitable for the intended purpose and contents, including but not limited to, plastic, glass, metal, ceramics, and cardboard or laminate thereof. For example, the components of a spray container can be made of PVC, polypropylene, PVDF, brass (including, but not limited to, nickel-plated brass), steel (including, but not limited to, stainless steel), ceramics, or other material not reactive with or degraded by the liquid within the container. In certain aspects, siphon channels may be made of a flexible material, such as organic or silicone polymers.

According to certain embodiments, the orientation-sensitive valves and spray containers of the invention can have any suitable purpose, and the container bodies can have any shape suitable for such purpose. For example, the orientation-sensitive valves and spray containers can be for dispensing perfume, cleaning agents, or chemical formulations, and the container bodies can have shapes suitable for such respective purposes.

According to further embodiments, a spray container may comprise more than one orientation-sensitive valve. For example, a spray container may have two orientation sensitive-valves positioned with respect to each other to allow for operability in any position within one 180° range, as well as operability in any position in an orthogonal 180° range.

The present invention has been conceptually reduced to practice and should not be considered limited to the specific examples described herein. Various modifications, equivalent processes, as well as numerous structures and devices to which the present invention may be applicable will be readily apparent to those of skill in the art. Those skilled in the art will understand that various changes may be made without departing from the scope of the invention, which is not to be considered limited to what is described in the specification.

What is claimed is:

1. A multi-channel valve, comprising:
at least first and second siphon channels comprising first ends that are operably connected to each other;
at least one actuator, the actuator capable of movement between at least a first and a second position;
a slide channel positioned between the first and second siphon channels;
a slide member housed within the slide channel and capable of movement therein, the slide member operably connected to the actuator and of sufficient dimensions to occlude at least one of the first and second siphon channels;
wherein movement of the actuator causes movement of the slide member such that when the actuator is in the first position, the slide member occludes the first siphon channel, and when the actuator is in the second position, the slide member occludes the second siphon channel.

2. The valve of claim 1, wherein the actuator is selected from levers, switches, and clamping assemblies.

3. The valve of claim 2, wherein the actuator is a switch.

4. The valve of claim 2, wherein the actuator is a weighted lever that is pivotally mounted such that it moves in response to gravity, the lever comprising a first end that engages the slide member and a weighted second end;
wherein when the valve is increasingly oriented away from a substantially vertical position, the second end of the weighted lever shifts in response to gravity causing the weighted lever to move towards one of the first or second positions, and the slide member moves to increase occlusion of one of the first and second siphon channels while decreasing occlusion of the other of the first and second siphon channels by a corresponding amount.

5. The valve of claim 4, wherein when the valve is oriented in the substantially vertical position, the slide member occludes from about 45% to about 55% of each of the first and second siphon channels such that combined occlusion is equivalent to 100% of the cross-sectional area of one siphon channel.

6. The valve of claim 4, wherein when oriented away from the substantially vertical position by from 1 to 30°, the slide member occludes from about 0% to about 15% of one of the first or second siphon channels and from about 85% to about 100% of the other of the first and second siphon channels such that combined percentage occlusion is equivalent to 100% of the cross-sectional area of one siphon channel.

7. The valve of claim 6, wherein when oriented away from the substantially vertical position by from about 5° to about 15°, the slide member occludes about 0% of one of the first or second siphon channels and about 100% of the other of the first and second siphon channels.

8. The valve of claim 4, comprising:
a lever chamber defined between the first and second siphon channels and positioned either above or below the slide channel; wherein the weighted lever is pivotally mounted within the lever chamber.

9. The valve of claim 4, wherein the second end of the lever is operably connected to a weight.

10. A multi-channel valve, comprising:
at least first and second siphon channels comprising first ends that are operably connected to each other;
at least one actuator capable of movement between at least a first and a second position, the actuator comprising: (A) a first valve chamber operably connected to the first siphon channel, the first valve chamber comprising: (i) a first valve seat; (ii) a second valve seat; and (iii) a first weighted valve member capable of alternately seating against the first and second valve seats in response to gravity; wherein when the actuator is in the first position, the first weighted valve member is seated against the second valve seat and occludes the first siphon channel; and (B) a second valve chamber operably connected to the second siphon channel, the second valve chamber comprising: (i) a first valve seat; (ii) a second valve seat; and (iii) a second weighted valve member capable of alternately seating against the first and second valve seats in response to gravity; wherein when the actuator is in the second position, the second weighted valve member is seated against the second valve seat and occludes the second siphon channel;
wherein when the valve is increasingly oriented away from a substantially vertical position, the weighted valve members shift in response to gravity and move to the first or second positions to occlude one of the first and second siphon channels.

11. A spray container operable in a plurality of positions, the spray container comprising:
a container body comprising a bottom;
a sprayer head operably connected to the container body;
at least one multi-channel valve operably connected to the sprayer head, the multi-channel valve comprising: (i) at least first and second siphon channels comprising first ends that are operably connected to each other and independent second ends; (ii) at least one actuator, the actuator capable of movement between at least a first and a second position; (iii) a slide channel positioned between the first and second siphon channels; (iv) a slide member housed within the slide channel and capable of movement therein, the slide member operably connected to the actuator and of sufficient dimensions to occlude at least one of the first and second siphon channels; wherein movement of the actuator causes movement of the slide member;
at least first and second dip tubes, each comprising (i) a first end operably connected with one of the second ends of the first and second siphon channels, and (ii) a second end proximate to the bottom of the container body;
wherein when the actuator is in the first position, the first siphon channel is occluded and communication between the container body and sprayer head is disrupted, and when the actuator is in the second position, the second siphon channel is occluded and communication between the container body and sprayer head is disrupted.

12. The spray container of claim 11, wherein the actuator is selected from levers, switches, and clamping assemblies.

13. The spray container of claim 12, wherein the actuator is a switch.

14. The spray container of claim 12, wherein the actuator is a weighted lever that is pivotally mounted such that it moves in response to gravity, the lever comprising a first end that engages the slide member and a weighted second end;
wherein when the spray container is oriented away from a substantially vertical position, the second end of the weighted lever shifts in response to gravity causing the weighted lever to move towards one of the first or second positions, and the slide member moves to increase occlusion of one of the first and second siphon channels while decreasing occlusion of the other of the first and second siphon channels by a corresponding amount, thereby increasing communication between the container body and the sprayer head via one of the first and second dip tubes while decreasing communication between the container body and the sprayer head via the other of the first and second dip tubes.

15. The spray container of claim 14, wherein when the container is oriented in the substantially vertical position, the slide member occludes from about 45% to about 55% of each of the first and second siphon channels such that combined occlusion is equivalent to 100% of the cross-sectional area of one siphon channel.

16. The spray container of claim 14, wherein when oriented away from the substantially vertical position from 1 to 30°, the slide member occludes from about 0% to about 15% of one of the first or second siphon channels and from about 85% to about 100% of the other of the first and second siphon channels such that combined percentage occlusion is equivalent to 100% of the cross-sectional area of one siphon channel.

17. The spray container of claim 16, wherein when oriented away from the substantially vertical position by from about 5° to about 15°, the slide member occludes about 0% of one of the first or second siphon channels and about 100% of the other of the first and second siphon channels.

18. The spray container of claim 14, comprising:
a lever chamber defined between the first and second siphon channels and positioned either above or below the slide channel; wherein the lever is pivotally mounted within the lever chamber.

19. The spray container of claim 11, wherein the sprayer head is selected from a trigger sprayer or pump sprayer.

20. The container of claim 11, wherein the first and second dip tubes are integrated with the sidewalls of the container body.

21. A spray container operable in a plurality of positions, the spray container comprising:
a container body comprising a bottom;
a sprayer head operably connected to the container body;
at least one multi-channel valve operably connected to the sprayer head, the multi-channel valve comprising: (I) at least first and second siphon channels comprising first ends that are operably connected to each other and independent second ends; (II) at least one actuator, the actuator capable of movement between at least a first and a second position, the actuator comprising: (A) a first valve chamber operably connected to the first siphon channel, the first valve chamber comprising: (i) a first valve seat; (ii) a second valve seat; and (iii) a first weighted valve member capable of alternately seating against the first and second valve seats in response to gravity; wherein when the actuator is in the first position, the first weighted valve member is seated against the second valve seat and occludes the first siphon channel; and (B) a second valve chamber operably connected to the second siphon channel, the second valve chamber comprising: (i) a first valve seat; (ii) a second valve seat; and (iii) a second weighted valve member capable of alternately seating against the first and second valve seats in response to gravity; wherein when the actuator is in the second position, the second weighted valve member is seated against the second valve seat and occludes the second siphon channel;
wherein when the spray container is increasingly oriented away from a substantially vertical position, the weighted valve members shift in response to gravity and move to the first or second positions;
at least first and second dip tubes, each comprising (i) a first end operably connected with one of the second ends of the first and second siphon channels, and (ii) a second end proximate to the bottom of the container body;
wherein when the actuator is in the first position, the first siphon channel is occluded and communication between the container body and sprayer head is disrupted, and when the actuator is in the second position, the second siphon channel is occluded and communication between the container body and sprayer head is disrupted.
